(19) United States
(12) Patent Application Publication
(10) Pub. No.: US 2013/0082525 A1
(43) Pub. Date: Apr. 4, 2013

(54) Shared Power System with Multiple Inputs

(71) Applicant: Hsing Chung SZU, Taipei City (TW)

(72) Inventor: Hsing Chung SZU, Taipei City (TW)

(73) Assignee: GCCA INC., Tortola (BV)

(21) Appl. No.: 13/248,742

(22) Filed: Sep. 29, 2011

(51) Int. Cl. H02J 1/10; H02J 1/00; H02J 4/00

(52) U.S. Cl. 307/26; 307/72; 307/43; 307/38; 307/29

(57) ABSTRACT

A shared power system includes a power router; a plurality of power input devices respectively connected to the power router; a first diode coupled between the power router and an output; a second diode coupled between a DC grid and the output; wherein the power router can provide power to the output by conducting the first diode when voltage of the power router is higher than the DC grid, and the DC grid can provide power to the output by conducting the second diode when voltage of the DC grid is higher than the power router. The power router can further determine the energy ratio between each power input device to achiever the energy-sharing.

### FIELD OF THE INVENTION

The present invention generally relates to a power system, in particular, to a shared power system with multiple inputs.

### DESCRIPTION OF THE PRIOR ART

Recently, energy-saving and carbon-reducing plays a pretty important role in the industry owning to the global warming Hence, the alternative energy (including solar energy, and wind energy, etc) must be the major power source in the future.

In the prior art, the well-known solar energy systems contains the following types. The first one is the independent power storage system. In this case, the power absorbed by the solar photovoltaic panel can be transferred and stored in the battery bank. If necessary, the stored power can be converted from DC to AC by an inverter, and subsequently transmitted via the wires, and finally converted from AC to DC for applying on ordinary electronic devices. The second one is the feedback-type power system. In this case, the power company can provide commercial power when the loading is heavier and the solar energy is insufficient. On the other hand, the surplus power can be feed back to the power company when the output loading is lower. The third one is a collaborative system. In this case, the solar energy is directly converted to AC for applying on electrical devices. If the solar energy is insufficient, the commercial power can be introduced.

In view of the foregoing, it can be acknowledged that the traditional solar energy system requires two converting process, one is to convert DC to AC, and anther one is to convert AC back to DC. Therefore, the power efficiency is quite low.

Based on aforementioned description, there are still some difficulties and problems existing in the related prior art of the power system.

### SUMMARY OF THE INVENTION

In view of the foregoing, the present invention provides a power system with multiple inputs, so as to overcome aforementioned difficulties and shortcomings.

One purpose of the present invention is to provide a power system with a power router, which adopts various power input devices including a solar photovoltaic panel, an AC power source, a battery bank, or a DC power source. The power router can generate uniform output voltage for the output without applying two converting process as the prior art does. Additionally, the power router can further choose the input device or determine the energy ratio of each power input device.

In order to meet aforementioned purpose, the present invention provides a power system with multiple inputs, which comprises: a power router; a plurality of power input devices respectively connected to the power router; a output connected to the power router; wherein the plurality of power input devices including a solar photovoltaic panel, an AC power source, a battery bank, or a DC power source; and wherein the power router including a control unit, whereby determining energy ratio between each of the power input devices.

Another purpose of the present invention provides a power system having a power router integrated with a DC grid. By this configuration, the present invention can not only employ the power sources of the power router, but also utilize the energy from an external DC grid. Furthermore, the present invention can determine to utilize the power router or the DC grid based on their voltage. Besides, the power router of the present invention can share energy with the DC grid when the voltage of the power router is higher than the DC grid.

In order to achieve aforementioned purpose, the present invention further provides a power system with multiple inputs, which comprises: a power router; a plurality of power input devices respectively connected to the power router; a output connected to the power router; a DC grid coupled to the output; a first diode coupled between the power router and the output; a second diode coupled between the DC grid and the output; wherein the power router provides power to the output by conducting the first diode when voltage of the power router is higher than the DC grid, and the DC grid provides power to the output by conducting the second diode when voltage of the DC grid is higher than the power router.

In another aspect of the present invention, a shared power system may be further provided, and it comprises: a plurality of power routers; a plurality of first diodes respectively coupled to the power routers; a plurality of outputs respectively coupled to the first diodes; a plurality of second diodes respectively coupled to the outputs; a DC grid coupled to the second diodes; a plurality of relays respectively coupled between the first diodes and the DC grid, whereby making the power router share power to the DC grid when voltage of the power router is higher than DC grid; wherein the power router provides power to the output by conducting the first diode when voltage of the power router is higher than the DC grid, and the DC grid provides power to the output by conducting the second diode when voltage of the DC grid is higher than the power router.

By aforementioned feature, every power router can share power to the DC grid when the voltage of the power router is higher than the DC grid, and further, the DC grid can provide power to the output when the energy of the power router providing power for that output is insufficient. As a result, every power router can indirectly share its power with another through the DC grid. Therefore, the energy of all users is sharable via the power system, so that the effect of energy-sharing can be implemented.

Aforementioned description is to illustrate purposes of the present invention, technical characteristics to achieve the purposes, and the advantages brought from the technical characteristics, and so on. And the present invention can be further understood by the following description of the preferred embodiment accompanying with the claims.

### BRIEF DESCRIPTION OF THE DRAWINGS

FIG. 1 shows one embodiment of the present invention;

FIG. 2 shows another embodiment of the present invention;

FIG. 3 shows still another embodiment of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

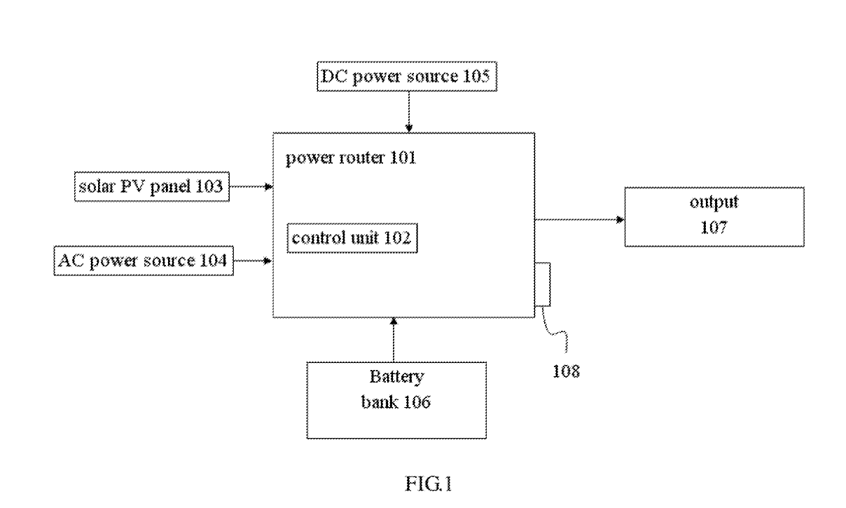

Referred to FIG. 1, this figure shows one embodiment of the power system with multiple inputs of the present invention. The power router 101 in the present invention has at least five different ports individually connected to a solar photovoltaic panel 103, an AC power source 104, a battery bank 106, a DC power source 105, and a output 107. In this embodiment, the solar photovoltaic panel 103 is coupled to the power router 101 for providing solar energy. The AC power source 104 is coupled to the power router 101 for providing AC power. The DC power source 105 is coupled to the power router 101 for providing DC power. And the output 107 is coupled to the power router 101 for receiving the power received from the power router 101.

In some embodiments, the power router 101 may just utilize one kind of power source to provide energy rather than mixing with others. For instance, the power router 101 can just transmit power of solar photovoltaic panel 103 to the output 107. In some embodiments, the control unit 102 may be further introduced in the power router 101 for controlling or determining the energy ratio between aforementioned power sources (including the solar photovoltaic panel 103, an AC power source 104, a battery bank 106, a DC power source 105, and a output 107). For example, 50% energy provided for the output 107 may be acquired from the solar photovoltaic panel 103, and 30% may be acquired from the battery bank 106, and the 10% may be acquired from the AC power source 104. 10% may be acquired from the DC power source 105. Aforementioned example of the energy ratio is determined by the control unit 102, which may include an IC for executing the determining process. Besides, the present invention can further employ a connecter 108 on the power router 101. The connector 108 can be connected to a remote terminal (ex: a computer), so that the remote terminal can control the control unit 102 for determining the energy ratio. Besides, the remote terminal can also monitor the efficiency of the power system. In some embodiments, the connector may include a RS232 connector, a RS485 connector, or the like. In some embodiments, the present invention may further include plural battery status lines (not shown) connected to the battery bank 106 for detecting and monitoring the remaining electric quantity.

Generally speaking, the solar photovoltaic panel 103 can modify the working cycle of the inverter therein to generate the maximum power by feeding the output voltage and current back and calculating the difference of power at different time, whereby providing the maximum power to the power router 101.

In this embodiment, the voltage of the solar photovoltaic panel 103 may range from 150-550V, preferred 500V. The voltage of the AC power source 104 may be 110 or 220V, and the frequency may be 50 or 60 Hz. In some embodiments, the AC power source 104 can be acted as the backup power source when the energy of the solar photovoltaic panel 103 and the battery bank 106 is insufficient. In other words, the AC power source 104 can be paused if the energy of the solar photovoltaic panel 103 or the battery bank 106 is enough, thereby saving the cost derived from the commercial power. In some embodiments, if the output 107 requires 135V of voltage and 3 kW of power, the power router 101 can convert the energy from solar photovoltaic panel 103, the AC power source 104, the DC power source 105 and the battery bank 106 to the uniform output (135V, 22 A, DC), so as to satisfy the demand of the output 107.

Because the power router 101 can output uniform DC to the output 107, the power system of the present invention can be widely applied on various electronic devices requiring DC, such as a notebook, a LED light, a power supply, a network router, or the like.

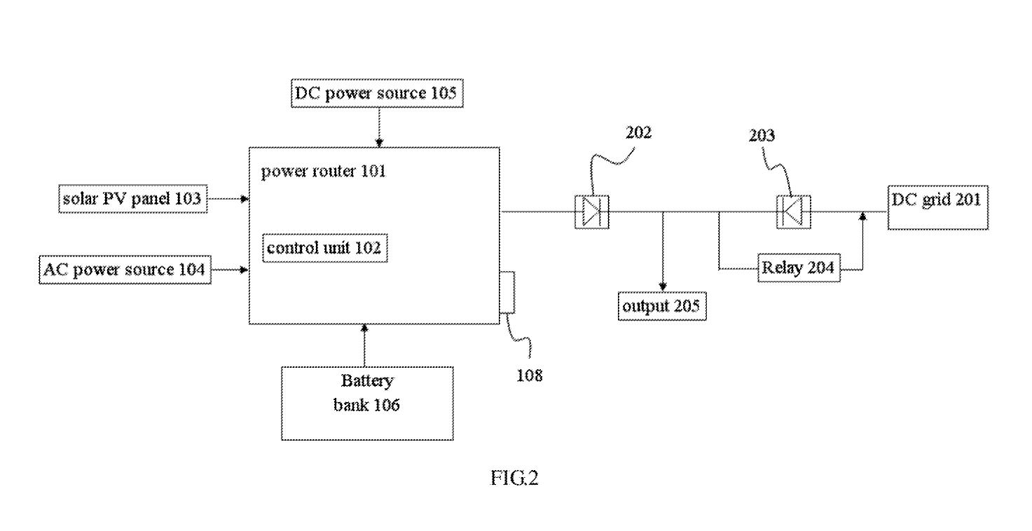

Referred to FIG. 2, this figure shows the preferred embodiment of the power system with multiple inputs. The outstanding feature of this embodiment is that the power system can employ the power router 101 or the DC grid 201 for providing energy to the output 107. In this figure, the power router 101 is still connected to the solar photovoltaic panel 103, the AC power source 104, the DC power source 105, and the battery bank 106 for receiving power from these devices. Additionally, the power router 101 also comprises the control unit 102 for determining the energy ratio between these devices. In the embodiment, the anode of the first diode 202 is coupled to the anode of the power router 101, and the output 107 is coupled to the cathode of the first diode 202. On the other hand, the anode of the second diode 203 is coupled to the anode of the DC grid 201, and the output 107 is coupled to the cathode of the second diode 203. Therefore, based on the intrinsic feature of the diode, which implies that the diode can just generate unidirectional current, the output 107 may receive the power from the power router 101 when the voltage of the power router 101 is higher than the DC grid 201 because the diode 202 is conducted while the diode 203 is not. Similarly, the output 107 may receive the power from the DC grid 201 when the voltage of the DC grid 201 is higher than the power router 101 because the diode 203 is conducted while the diode 202 is not. Based on aforementioned description, the wire or cable connected between the first diode 202 and the second diode 203 can be regarded as a DC bus for bridging two different power sources. Furthermore, the present invention can automatically choose the power source with higher voltage for supplying power to the output 107, thereby balancing the energy consumption of either side.

Additionally, the power system may further contain a relay 204 coupled between the first diode 202 and the DC grid 201, so that the energy of the power router 101 can be transmitted to the DC grid 201 through the relay 204 when the voltage of the power router 101 is higher than the DC grid 201, thereby achieving the effect of sharing energy. In some embodiments, the relay 204 is preferred to be a solid state relay (SSR). Preferably, the SSR can be normally opened, namely, the output of the SSR is always on, whereby facilitating the power router 101 to share power with the DC grid 201.

In some embodiments, the present invention may further comprises an emergency AC power source (not shown) coupled to the output 107 for providing power when the power router 101 and the DC grid 201 are unavailable. It has to be noted that the power router 101 must be turned off for preventing the current of the emergency AC power source from flowing back to the power router 101 and thereby breaking the power router 101 down. Therefore, the present invention can further employ a circuit breaker (not shown) connected between the power router 101 and the output 107 for protecting the power router 101.

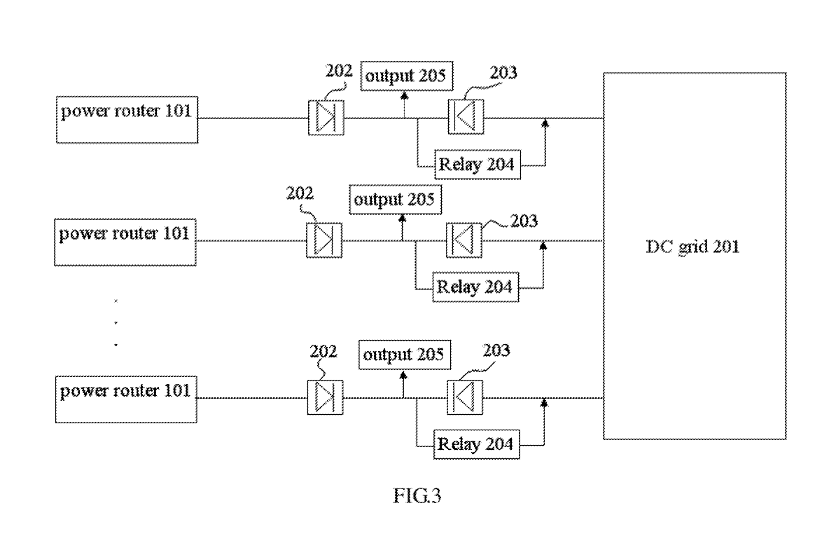

FIG. 3 shows the preferred embodiment of the shared power system of the present invention. In this figure, the shared power system contains plural power routers 101, plural first diodes 202 respectively coupled to the power routers 101, plural outputs 105 respectively coupled to the first diodes 202, plural second diodes 203 respectively coupled to the outputs 205, a DC grid 201 coupled to the plural second diodes 203, and plural relays 204 respectively coupled between the corresponding first diodes 202 and the DC grid 201, namely, each relay 204 is connected between the first diode 202 and the DC grid 201 across the second diode 203. Therefore, every power router 101 can share power to the DC grid 201 via the relay 204 when the voltage of the power router 101 is higher than the DC grid 201, and further, the DC grid 201, instead of the power router 101, can provide power to the output 205 when voltage of the power router 101 is lower than the DC grid 201. As a result, every power router 101 can indirectly share its power with another through the DC grid 201. Therefore, the energy of all users is sharable via the power system.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A power system with multiple inputs, comprising:
a power router;
a plurality of power input devices respectively connected to said power router;
an output connected to said power router;
wherein said plurality of power input devices including a solar photovoltaic panel, an AC power source, a battery bank, or a DC power source; and
wherein said power router including a control unit, whereby determining energy ratio between each of said power input devices.

2. The system according to claim 1, wherein said power router contains a connector for connecting to at least one computer, whereby controlling said control unit to determine energy ratio between each of said power input devices.

3. The system according to claim 2, wherein said connector includes a RS232 or RS485 connector.

4. A power system with multiple inputs, comprising:
a power router;
a plurality of power input devices connected to said power router;
a output connected to said power router;
a DC grid coupled to said output;
a first diode coupled between said power router and said output;
a second diode coupled between said DC grid and said output;
wherein said power router provides power to said output by conducting said first diode when voltage of said power router is higher than said DC grid, and said DC grid provides power to said output by conducting said second diode when voltage of said DC grid is higher than said power router.

5. The system according to claim 4, wherein anode of said first diode is coupled to anode of said power router, and cathode of said first diode is coupled to said output.

6. The system according to claim 4, wherein anode of said second diode is coupled to anode of said DC grid, and cathode of said second diode is coupled to said output.

7. The system according to claim 4, wherein said plurality of power input devices including a solar photovoltaic panel, an AC power source, a battery bank, or a DC power source.

8. The system according to claim 4, wherein said power router includes a control unit, whereby determining energy ratio between each of said power input devices.

9. The system according to claim 8, wherein said power router contains a connector for connecting at least one computer, whereby controlling said control unit to determine energy ratio between each of said power input devices.

10. The system according to claim 9, wherein said connector includes a RS232 or RS485 connector.

11. The system according to claim 4, further comprising a relay coupled between said DC grid and said first diode, whereby making said power router share power to said DC grid when voltage of said power router is higher than DC grid.

12. The system according to claim 11, wherein said relay is a solid state relay. output

13. A shared power system with multiple inputs, comprising:
a plurality of power routers;
a plurality of first diodes respectively coupled to said power routers;
a plurality of outputs respectively coupled to said first diodes;
a plurality of second diodes respectively coupled to said outputs;
a DC grid coupled to said second diodes;
a plurality of relays respectively coupled between said first diodes and said DC grid, whereby making said power router share power to said DC grid when voltage of said power router is higher than DC grid;
wherein said power router provides power to said output by conducting said first diode when voltage of said power router is higher than said DC grid, and said DC grid provides power to said output by conducting said second diode when voltage of said DC grid is higher than said power router.

14. The system according to claim 13, wherein each of said power routers connects to a plurality of power input devices.

15. The system according to claim 14, wherein said plurality of power input devices include a solar photovoltaic panel, an AC power source, a battery bank, or a DC power source.

16. The system according to claim 14, wherein each of said power router includes a control unit, whereby determining energy ratio between each of said power input devices.

17. The system according to claim 14, wherein each of said power router contains a connector for connecting at least one computer, whereby controlling said control unit to determine energy ratio between each of said power input devices.

18. The system according to claim 13, wherein anode of said first diodes is coupled to anode of said power routers, and cathode of said first diodes is coupled to said output.

19. The system according to claim 13, wherein anode of said second diode is coupled to anode of said DC grid, and cathode of said second diode is coupled to said output device.

20. The system according to claim 13, wherein each of said relay is a solid state relay.
